(19) United States
(12) Patent Application Publication
(10) Pub. No.: US 2004/0181908 A1
(43) Pub. Date: Sep. 23, 2004

(54) Hinge for a notebook computer

(75) Inventors: Sheng-Nan Lu, Shulin City (TW); Chung-Yu Lee, Shulin City (TW)

Correspondence Address: BACON & THOMAS, PLLC, 625 SLATERS LANE, FOURTH FLOOR, ALEXANDRIA, VA, 22314

(73) Assignee: SHIN ZU SHING CO., LTD.

(21) Appl. No.: 10/388,423

(22) Filed: Mar. 17, 2003

(51) Int. Cl. E05D 11/10

(52) U.S. Cl. 16/319

(57) ABSTRACT

A hinge for a notebook computer in accordance with the present invention comprises a stationary leaf, a rotating leaf and a sleeve. The stationary leaf and the rotating leaf each have an extension, a pintle and a protrusion. The two extensions are adapted to attach to the notebook computer. The two pintles are mounted in the sleeve from opposite ends of the sleeve, and the sleeve is pivoted relative to only one pintle and the another pintle pivots with the sleeve. The pivoting pintle has a longitudinally keyed surface, and the sleeve has a planar key to abut the keyed surface when the monitor is closed against the body. The hinge has simple structure and is conveniently positioned and assembled.

### BACKGROUND OF THE INVENTION

1. Field of the Invention

The present invention relates to a hinge for a notebook computer, and more particularly to a hinge that can effectively position a monitor towards a body to close the notebook computer and has a simple structure.

2. Description of Related Art

Computers have become a common tool used almost everyday in most homes. The computer not only makes previously complicated tasks relatively simple, but allows people to do things previously considered impossibly complex or difficult, to acquire new knowledge, send letters and orders by E-mail and so on. In modern life, computers are playing a more and more important role. For people required to work or speak away from their offices, notebook computers are becoming common tools of business people because notebook computers are convenient to take out of the office and use.

A notebook computer has a body and a monitor pivotally attached to the body by a hinge. Since the monitor must be held in different positions that depend on the location a person uses the notebook computer, conventional hinges generally have complex structures. Conventional hinges include basic elements such as a pintle, a barrel and seats and auxiliary elements such as positioning rings, collars, resilient members and so on. Assembling conventional hinges is inconvenient and time-consuming. Moreover, the conventional hinges with many elements are expensive.

Therefore, the invention provides a hinge for a notebook computer to mitigate or obviate the aforementioned problems.

### SUMMARY OF THE INVENTION

The main objective of the present invention is to provide a hinge for a notebook computer with a monitor and a body, which can effectively hold the monitor in position, has a simple structure and is inexpensive.

To achieve the objective, the hinge comprises a stationary leaf, a rotating leaf and a sleeve. The stationary leaf and the rotating leaf each have an extension, a pintle and a protrusion. The two extensions are adapted to be attached to the notebook computer. The two pintles are mounted in the sleeve from opposite ends of the sleeve, and the sleeve is pivoted relative to one pintle, and the other pintle pivots with the sleeve. The pivoting pintle has a longitudinally keyed surface, and the sleeve has a planar key to abut the keyed surface when the monitor is closed against the body. The hinge has a simple structure and is conveniently positioned and assembled.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hinge for a notebook computer in accordance with the present invention;

FIG. 2 is an exploded perspective view of the hinge in FIG. 1;

FIG. 3 is a side plan view in partial section of the hinge in FIG. 1;

FIG. 4 is a cross sectional end view of the hinge in FIG. 1 with the notebook computer monitor closed;

FIG. 5 is a cross sectional end view of the hinge in FIG. 1 with the notebook computer monitor open; and

FIG. 6 is an operational perspective view of a preferred embodiment of the hinge in FIG. 1 with a notebook computer.

### DETAILED DESCRIPTION OF THE INVENTION

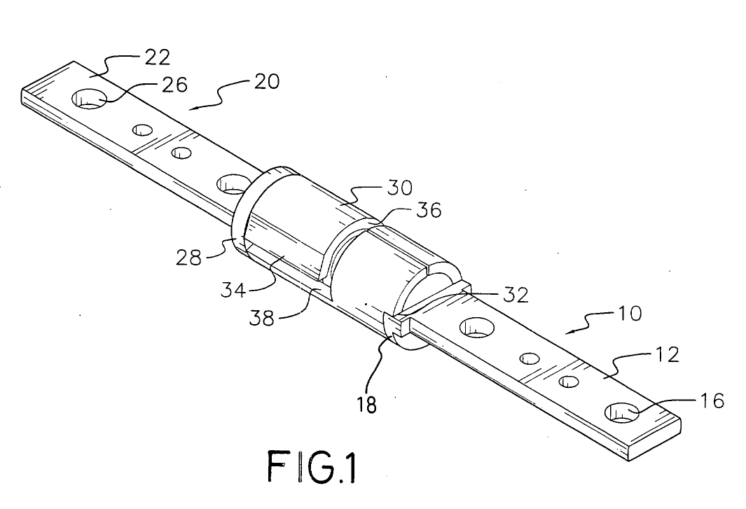

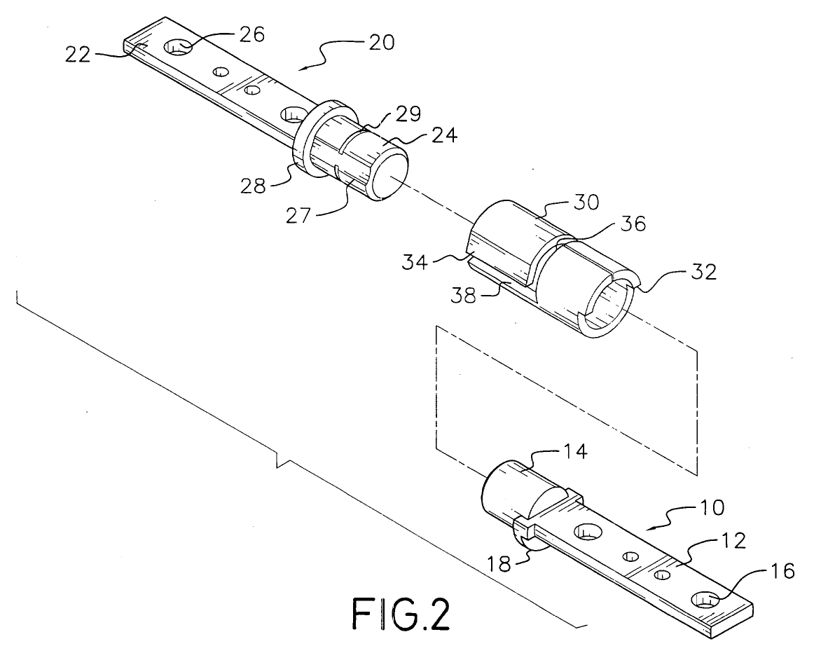

With reference to FIGS. 1 and 2, a hinge for a notebook computer with a body (not shown) and a monitor (not shown) in accordance with the present invention comprises a stationary leaf (10), a rotating leaf (20) and a sleeve (30). The stationary leaf (10) has a stationary extension (12), a stationary pintle (14) and a semi-circular protrusion (18). The stationary extension (12) has a distal end (not numbered), a proximal end (not numbered) and multiple through holes (16). The multiple through holes (16) are used to attach the stationary extension (12) to either the body or the monitor of a notebook computer (not shown). The stationary pintle (14) is cylindrical and is formed integrally with and extends from the proximal end of the extension (12) at a joint (not numbered). The stationary pintle (14) has an outer radius (not numbered). The semi-circular protrusion (18) extends radially from the stationary pintle (14) at the joint with the stationary extension (12).

The rotating leaf (20) has a rotating extension (22), a rotating pintle (24) and a circular protrusion (28). The rotating extension (22) has a distal end (not numbered), a proximal end (not numbered) and multiple through holes (26). The multiple through holes (26) are used to attach the extension (22) to either the body or the monitor of the notebook computer. The rotating pintle (24) is cylindrical and is formed integrally with and extends from proximal end of the extension (12) at a joint (not numbered). The circular protrusion (28) extends radially from the rotating pintle (24) at the joint with the rotating extension (22). The rotating pintle (24) has an outer periphery (not numbered), an outer radius (not numbered), a keyed surface (27) and an annular groove (29). The keyed surface (27) is formed longitudinally on the outer periphery of the rotating pintle (24), and the annular groove (29) is formed radially in the outer periphery.

The sleeve (30) is hollow and has a stationary connection end (not numbered), a rotating connection end (not numbered), an outer periphery (not numbered), an inner radius (not numbered), a semi-circular recess (32), a planar key (34), a slot (36) and a gap (38). The semi-circular recess (32) is radially defined in the stationary connection end. The planar key (34) is longitudinally defined in the sleeve (30). The gap (38) is defined longitudinally adjacent to the planar key (34) through the outer periphery of the sleeve (30). The slot (36) is defined radially through the outer periphery of the sleeve (30) and communicates with the gap (38). The inner radius of the sleeve (30) corresponds to the outer radius of the stationary pintle (14) and the rotating pintle (24).

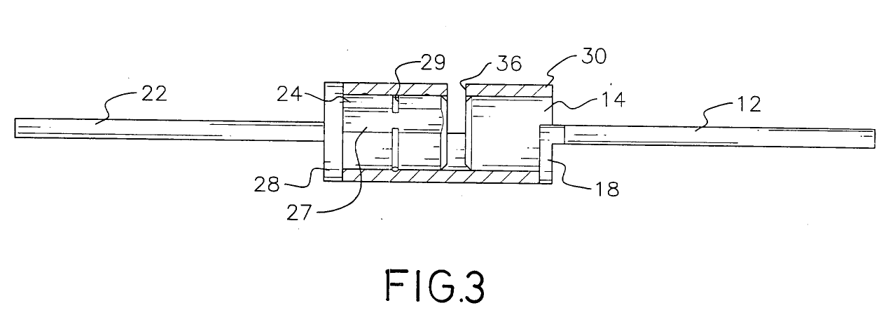

With further reference to FIG. 3, the stationary pintle (14) is mounted in the stationary connection end of the sleeve (30) when the hinge is assembled. The semi-circular protrusion (18) on the stationary leaf (10) is mounted in the semi-circular recess (32) in the sleeve (30) to cause the sleeve (30) and the stationary leaf (10) to combine together. In another embodiment, the stationary leaf (10) is integrally formed and extends from the stationary connection end of the sleeve (30) to make the sleeve (30) with the stationary leaf (10) a single part. The rotating pintle (24) is pivotal mounted in the rotating connection end of the sleeve (30), and the circular protrusion (28) on the rotating leaf (20) abuts the rotating connection end of the sleeve (30). A gap is formed between the stationary pintle (14) and the rotating pintle (24) corresponding to the slot (36) in the sleeve (30) when the stationary pintle (14) and the rotating pintle (24) are mounted in the sleeve (30).

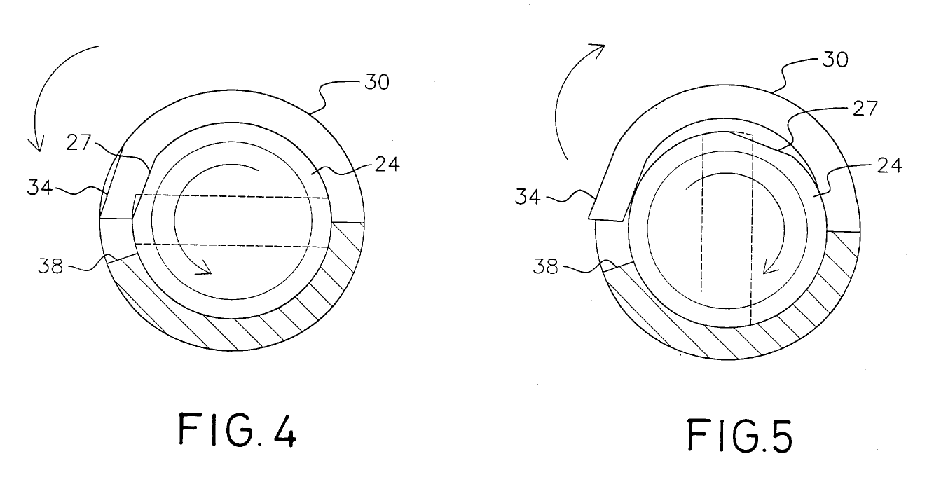

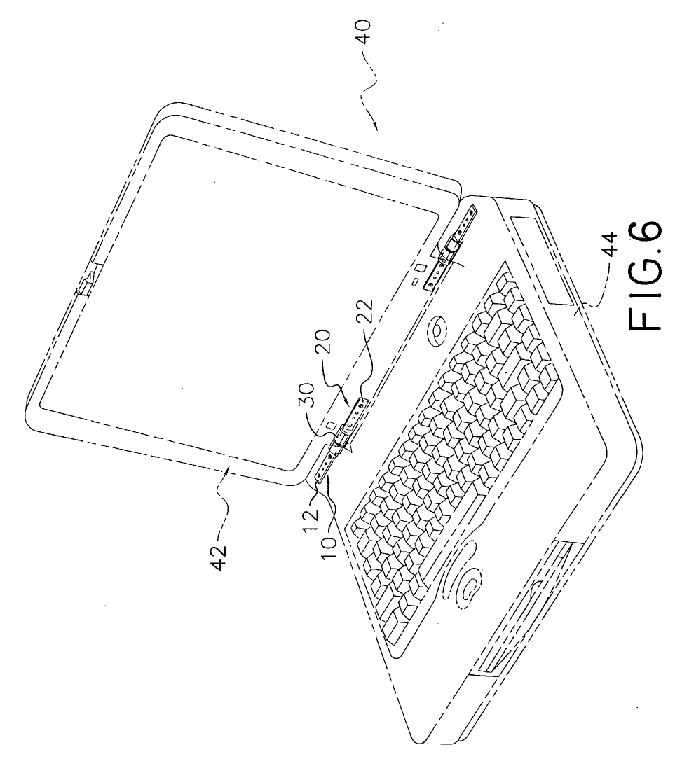

With further reference to FIGS. 4 to 6, the hinge is attached to a notebook computer (40) with a monitor (42) and a body (44) by connecting the rotating leaf (20) to the monitor (42) and the stationary leaf (10) to the body (44). When the monitor (42) is closed and abuts the body (44), the rotating pintle (24) is pivoted in the sleeve (30) so the planar key (34) in the sleeve (30) aligns with and abuts to the keyed surface (27) on the rotating pintle (24) of the rotating leaf (20) to hold the monitor (42) closed. When the monitor (42) is pivoted away from the body (44), the keyed surface (27) on the rotating pintle (24) disengages from the planar key (34) in the sleeve (30), and the rotating pintle (24) slightly pushes the sleeve (30) outward and generates a restitution force in the sleeve (30). The sleeve (30) can move outward due to the slot (36) and the gap (34). The restitution force in the sleeve (30) causes the sleeve (30) to squeeze the outer periphery of the rotating pintle (24) to hold the monitor (42) at any angle relative to the body (44). The user can easily and conveniently pivot and position the monitor (42).

The hinge is composed of two different leafs (10, 20) that are respectively connected to the monitor (42) and the body (44). The hinge hold the monitor (42) closed against the body (44) or open at any angle relative to the body (44). Furthermore, the hinge has a simple structure that makes production and assembly of the hinge convenient.

Although the invention has been explained in relation to its preferred embodiment, it is to be understood that many other possible modifications and variations can be made without departing from the spirit and scope of the invention as hereinafter claimed.

What is claimed is:

1. A hinge for a notebook computer comprising:
a hollow sleeve having a stationary connection end, a rotating connection end, an outer periphery, an inner radius, a planar key, a groove and a gap, wherein
the planar key is longitudinally defined through the sleeve at the rotating connection end;
the gap is defined through the outer periphery of the sleeve adjacent to the planar key; and
the slot is radially defined through the outer periphery of the sleeve and communicates with the gap;
a stationary leaf securely mounted in the stationary connection end of the sleeve and having;
a stationary extension having multiple through holes to attach the stationary extension to a notebook computer; and
a cylindrical stationary pintle formed integrally with and extending from the stationary extension at a joint, securely connected to the stationary connection end of the sleeve and having an outer radius; and
a rotating leaf rotatably attached to the rotating connection end of the sleeve and having;
a rotating extension having multiple through holes to the rotating extension to a notebook computer;
a cylindrical rotating pintle formed integrally with and extending from the rotating extension at a joint and having an outer periphery, an outer radius and a keyed surface formed longitudinally in the outer periphery; and
a circular protrusion extending radially from the rotating pintle at the joint between the rotating pintle and the rotating extension.

2. The hinge for a notebook computer as claimed in claim 1, wherein a semi-circular protrusion extending radially from the stationary pintle at the joint between the stationary pintle and the stationary extension; and
a semi-circular recess is radially defined in the stationary connection end of the sleeve and abuts to the semi-circular protrusion on the stationary leaf.

3. The hinge for a notebook computer as claimed in claim 1, wherein the inner radius of the sleeve corresponds to the outer radius of the stationary pintle and the rotating pintle.

4. The hinge for a notebook computer as claimed in claim 1, wherein an annular groove is formed in the outer periphery of the rotating pintle.
